(19) United States
(12) Patent Application Publication
(10) Pub. No.: US 2006/0240830 A1
(43) Pub. Date: Oct. 26, 2006

(54) Apparatus, method and computer program providing fast, zero data loss high speed data packet access (HSDPA) serving cell change

(75) Inventors: Karri Ranta-aho, Espoo (FI); Antti Toskala, Espoo (FI); Esa Malkamaki, Espoo (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/410,802

(22) Filed: Apr. 24, 2006

Related U.S. Application Data
(60) Provisional application No. 60/674,987, filed on Apr. 25, 2005.

(51) Int. Cl. H04Q 7/20

(52) U.S. Cl. 455/436

(57) ABSTRACT

To handover a mobile terminal from a serving base station BTS to a target BTS, a radio network controller RNC: 1) informs the mobile terminal of the pending handover so it can preconfigure to communicate with the target BTS; 2) indicates to the serving BTS which will be the last data packet prior to handover; and 3) informs the target BTS of the pending handover and the mobile terminal's identity. The serving BTS indicates which is the last data packet and sends it to the mobile terminal. Upon receiving an acknowledgement, the serving BTS informs the RNC. The BTS automatically switches to the target BTS after receiving the last data packet from the serving BTS, informs the target BTS that it is ready to receive data from it by a handover confirmation message, and the target 1) schedules the mobile terminal to receive data; and 2) informs the RNC that the mobile terminal is handed over.

### CROSS REFERENCE TO RELATED APPLICATION

This application claims priority to U.S. Provisional Patent Application No. 60/674,987, filed on Apr. 25, 2005, the content of which is hereby incorporated by reference.

### TECHNICAL FIELD OF THE INVENTION

The examples of this invention relate generally to digital cellular communications systems, methods, terminals and computer programs and, more specifically, relate to packet data transmission techniques for handing over a terminal from a currently serving cell to a next serving cell.

### BACKGROUND

The following abbreviations, at least some of which appear in the description below, are defined as follows:
3GPP Third Generation Partnership Project
ARQ Automatic Repeat Request
BTS Base Transceiver Station
CFN Connection Frame Number
CPICH Common Pilot Channel
DL Downlink
DPCH Dedicated Physical Channel
F-DPCH Fractional Dedicated Physical Channel
H-ARQ Hybrid ARQ
HSDPA High-Speed Downlink Packet Access
HS-DPCCH High-Speed Dedicated Physical Control Channel
HS-DSCH High-Speed Downlink Shared Channel
HS-PDSCH High-Speed Physical Downlink Shared Channel
HS-SCCH High-Speed Shared Control Channel
MAC Medium Access Control
RLC Radio Link Control
RNC Radio Network Controller
RNTI Radio Network Temporary Identifier
RRC Radio Resource Control
SRB Signaling Radio Bearer
TTI Transmission Time Interval
UE User Equipment
UL Uplink
UMTS Universal Mobile Telecommunications System C304
UTRA-FDD UMTS Terrestrial Radio Access-Frequency Division Duplex
UTRAN UMTS Terrestrial Radio Access Network
VoIP Voice Over Internet Protocol
WCDMA Wideband Code Division Multiple Access

The DL packet data transmission in UTRA FDD (WCDMA) is a feature included in Release 5 specifications (HSDPA) and is further enhanced in Release 6 with the support of fractional DPCH (F-DPCH) and with the support of SRB mapping on the HS-DSCH.

Currently there is development work proceeding for Release 7. One HSDPA improvement that is of most concern to this invention is to increase the speed of the handover process with HSDPA, particularly for real time applications such as VoIP. One proposal related to this problem has been presented in R1-050324 (3GPP TSG-RAN1 Meeting #40bis, 4-8 Apr. 2005, Beijing, China, Lucent Technologies), and another can be found in R2-050965 (3GPP TSG-RAN WG2 Meeting #46 bis, 4-8 Apr. 2005, Beijing, China, Qualcomm).

A problem is created in the current HSDPA specification as the HSDPA serving cell change implies an interruption in service to the UE. This is due to the fact that the network needs to ensure that the source HSDPA serving cell has sufficient time to empty its buffers before the cell change takes place, but without having precise knowledge as to how long this process will take. Relatedly, the network does not know exactly at point that it should stop sending UE packets for transmission to the source HSDPA serving cell.

In the current specifications the RNC commands the UE to make the serving HSDPA cell change at a specified time instant (CFN) that is sufficiently far in the future that the RNC can be confident that the source serving HSDPA cell has sent all buffered packets to the UE. Also, the target serving HSDPA cell can only begin transmitting after the specified time instant CFN. However, this procedure is not time efficient, and can result in a break in continuity of packet reception by the UE.

### SUMMARY

The foregoing and other problems are overcome, and other advantages are realized, in accordance with the herein described embodiments of these teachings.

In accordance with one embodiment of the invention is a system for handing over a mobile terminal from a serving base transceiver station BTS to a target BTS. The system includes a radio network controller RNC, a serving base transceiver station BTS, and a target BTS. The RNC has RNC means for communicating with the serving and target BTSs (e.g., a wire line or wireless link with either or both), and an RNC processor coupled to an RNC memory for executing a first set of instructions stored on the RNC memory. The executed first set of instructions operate to send a first message, directed to the mobile terminal, to one of the serving and target BTSs to preconfigure the mobile terminal for a handover to the target BTS. The first set of instructions further operate to send a second message to the serving BTS that includes a particular data packet directed to the mobile terminal and an indication that the particular data packet is a last data packet, and further the first set of instructions operate to send a third message to the target BTS informing of a pending handover of the mobile terminal to the target BTS. The serving BTS has serving means for communicating with the RNC (e.g., a wired or wireless link), a serving antenna coupled to a serving transceiver for communicating with the mobile terminal, and a serving processor coupled to a serving memory for executing a second set of instructions stored on the serving memory. The second set of instructions operate to send, responsive to receiving the first message, a fourth message to the mobile terminal identifying the particular data packet as the last data packet. Further, the second set of instructions operate to send, responsive to receiving at the serving antenna an acknowledgement of receipt by the mobile terminal of the particular data packet, a fifth message to the RNC informing of receipt by the serving BTS of the acknowledgement. The target BTS has target means for communicating with the RNC (e.g., a wired or wireless link), a target antenna coupled to a target transceiver for communicating with the mobile terminal, and a target processor coupled to a target memory for executing a third set of instructions stored on the target memory. The third set of instructions operate to receive the third message, and responsive to receiving a handover confirmation message from the mobile terminal, operate to send a sixth message to the RNC informing of receipt by the target BTS of the handover confirmation message. The third set of instructions also operates to thereafter schedule data packets for transmission to the mobile terminal via the target antenna.

In accordance with another embodiment of the invention is a method for operating a mobile terminal. In the method, a data packet and an indication that the said data packet is a last data packet to be sent from a serving base transceiver station BTS is received from the serving BTS. The mobile terminal recognizes the indication as a handover from the serving BTS. The mobile terminal may outwardly exhibit this recognition in various ways, such as for example reconfiguring a transceiver from a channel linking to the serving BTS to a channel linking to a target BTS, discontinuing monitoring the channel with the serving BTS over which the data packet and/or indication was received (or any control channel for that serving BTS), or sending a handover confirmation message to a target BTS informing that the mobile terminal is handed over to the target BTS.

In accordance with another embodiment of the invention is a mobile terminal that includes an antenna, a transceiver coupled to the antenna for receiving from a serving base transceiver station BTS a downlink data packet and an indication that the downlink data packet is a last data packet to be sent from the serving BTS, a processor coupled to the transceiver; and a memory coupled to the processor for storing a set of instructions that are executable by the processor. The set of instructions is for sending an uplink data packet to a target BTS after receiving the indication, where the target BTS is different from the serving BTS. The uplink data packet may be in a buffer of the mobile terminal, or may be compiled some time after the last data packet is received from the serving BTS.

In accordance with another embodiment of the invention is a program of machine-readable instructions, tangibly embodied on an information bearing medium and executable by a digital data processor, to perform actions directed toward handing over a mobile terminal between network elements. The actions include: 1) determining from a message received from a serving base transceiver station BTS that a data packet from the serving BTS is a last data packet to be received from the serving BTS, and 2) after determining as above, sending an uplink data packet to a target BTS. The uplink data packet need not be sent immediately after the determining. For example, an optional action may include, prior to sending the uplink data packet and responsive to receiving both the message and the data packet, compiling and sending a handover confirmation message to a target BTS informing that a mobile terminal in which the program is resident is handed over to the target BTS.

In accordance with another embodiment of the invention is a method for operating a serving base transceiver station BTS. In this method, a first indication that a handover of a mobile terminal from a serving BTS is about to occur is received from a radio network controller RNC. Following receipt of that first indication, the method proceeds with sending a message to the mobile terminal that indicates that a particular data packet is a last data packet.

In accordance with another embodiment of the invention is a serving network element that includes an antenna, a transceiver coupled to the antenna for receiving from a radio network controller RNC an indication that a handover of a mobile terminal from a serving network element is about to occur, a processor coupled to the transceiver, and a memory coupled to the processor for storing a set of instructions that is executable by the processor. The set of instructions operate to compile, following receipt of the indication, a message to the mobile terminal that identifies a particular data packet as a last data packet and for sending the message to the mobile terminal.

In accordance with another embodiment of the invention is a program of machine-readable instructions, tangibly embodied on an information bearing medium and executable by a digital data processor, to perform actions directed toward handing over a mobile terminal between network elements. The actions include: 1) determining from a first message received from a radio network controller RNC that a handover of a mobile terminal from a serving BTS in which the program is resident is about to occur, and 2) following receipt of that first message, compiling and sending a second message to the mobile terminal that identifies a particular data packet as a last data packet.

In accordance with another embodiment of the invention is a method for operating a target network element. In this method, a message that a handover of a mobile terminal is about to occur and a first data packet for the mobile terminal is received from a radio network controller RNC. A handover confirmation message is received from the mobile terminal. Responsive to receiving the message that a handover is about to occur, one or more radio resources of a target network element executing the method to the mobile terminal are allocated to the mobile terminal. Responsive to receiving a handover confirmation message, the first data packet is sent to the mobile terminal over the allocated radio resource(s).

In accordance with another embodiment of the invention is a target network element that includes an antenna, a transceiver coupled to the antenna, a processor coupled to the transceiver, and a memory coupled to the processor for storing a set of instructions that is executable by the processor. The transceiver is for receiving from a radio network controller RNC a message that a handover of a mobile terminal to the target network element is about to occur and a first data packet for the mobile terminal, and for subsequently receiving from the mobile terminal a handover confirmation message. The set of instructions is for allocating a radio resource of the target network element to the mobile terminal in response to receiving the message that a handover is about to occur, and for automatically sending the first data packet to the mobile terminal over the allocated radio resource in response to receiving the handover confirmation message.

In accordance with another embodiment of the invention is a program of machine-readable instructions, tangibly embodied on an information bearing medium and executable by a digital data processor, to perform actions directed toward handing over a mobile terminal between network elements. The actions include, responsive to receiving from a radio network controller RNC a message that a bandover of a mobile terminal is about to occur and a first data packet for the mobile terminal, allocating to the mobile terminal a radio resource of a target network element in which the program is resident. Further, responsive to receiving a handover confirmation message from the mobile terminal, the actions send the first data packet to the mobile terminal over the allocated radio resource.

In accordance with another embodiment of the invention is method for operating a radio network controller. In this method, a first message directed toward a mobile terminal informing the mobile terminal to configure for a pending handover to a target network element is sent. A second message is sent to a serving network element (i.e., that network element that is currently serving the mobile terminal) that identifies a particular data packet as a last data packet to be sent prior to the pending handover. The particular data packet is directed toward the mobile terminal. A third message is sent to the target network element informing of the pending handover and identifying the mobile terminal.

These embodiments and other aspects of the invention are more particularly described below.

### BRIEF DESCRIPTION OF THE DRAWINGS

The foregoing and other aspects of the teachings of this invention are made more evident in the following Detailed Description, when read in conjunction with the attached Drawing Figures, wherein:

FIG. 1 is a signaling diagram that shows message flow among a mobile terminal and network elements in accordance with one embodiment of this invention.

FIG. 2 is a process flow diagram showing the messages of FIG. 1 in sequential order in accordance with one embodiment of this invention.

### DETAILED DESCRIPTION

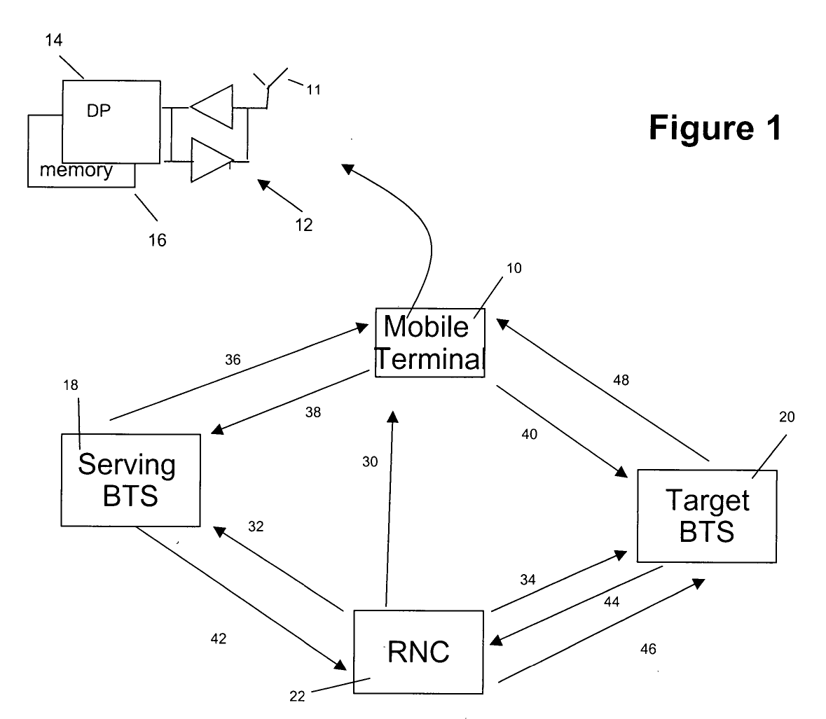

The major elements used to implement this invention are shown in FIG. 1, specifically a HSDPA terminal 10, also referred to as User Equipment (UE) or a mobile terminal 10, a first (source or currently serving) BTS 18, and a second (target) BTS 20.

As used herein, but not as a limitation on the practice of this invention, the BTS is assumed to be functionally equivalent to what is termed a Node B in the 3GPP 25-series specifications. Whether the handover is inter-Node B or intra-Node B is not relevant to this invention. In general, handover is assumed to refer to a cell change for the mobile terminal 10.

FIG. 1 shows that the mobile terminal 10 includes an antenna 11 coupled to a suitable wireless transceiver 12 coupled to a data processor (DP) 14 that in turn includes or is coupled to a volatile and/or non-volatile memory 16. The memory 16 stores program code that is executable by the DP 14 to operate with the serving 18 and target 20 BTSs, including program code that is provided to implement the mobile terminal 10 aspects of this invention. Although not shown, it will be appreciated that each BTS 18, 20 will be similarly constructed, and a corresponding memory stores program code that is provided to implement the BTS aspects of this invention. The RNC 22 will also include a DP and a memory that stores program code that is executable by the RNC DP to operate with the serving BTS 18 and the target BTS 20, as well as the mobile terminal 10, in order to implement the RNC-aspects of this invention. The serving BTS 18, the target BTS 20 and the RNC 22 may all be considered as network elements.

In accordance with the teaching of this invention, serving cell change with zero data loss may be implemented as follows. After the criteria to initiate an HSDPA serving cell change are met:

the RNC 22 preconfigures the mobile terminal 10 to the new HSDPA serving cell (the target BTS 20) and sets up target BTS 20;

the RNC 22 informs the serving BTS 18 of what is the last packet to be transmitted to the mobile terminal 10 via this cell, and begins sending the consecutive packets received from the core network (upstream of the RNC 22, not shown) to the target BTS 20;

the serving BTS 18 indicates to the mobile terminal 10 to hand over to a preconfigured target BTS 20 after the last packet is sent;

after receiving the last-packet-transmitted indication from the serving BTS 18, the mobile terminal 10 assumes the use of the preconfigured target BTS 20 as its current HSPDA serving cell and continues receiving packets from that BTS 20;

after receiving a positive acknowledgment from the mobile terminal 10 to the last-packet-transmitted indication, the serving BTS 18 (which at this point is no longer the serving cell for the mobile terminal 10, but terms are kept unchanged to avoid confusion) has knowledge that the handover transition was successful;

the serving BTS 18 may notify the RNC 22 of the success and/or failure of the last-packet-transmitted indication delivery to the mobile terminal 10;

the mobile terminal 10 notifies the target BTS 20 that it is now receiving (listening to) its transmissions (this notification may also originate from the RNC 22, but may require more time); and

the target BTS 20 may notify the RNC 22 of the success and/or failure of the serving cell change.

More specifically, the following steps are executed in an embodiment of the invention:

A. The RNC 22 preconfigures the mobile terminal 10 with information about the target BTS 20 (e.g., channel codes and frequencies, times at which to expect or to initiate contact with the target BTS 20, etc.).

B. The RNC 22 informs the serving BTS 18 that a cell change/handover is about to take place and that no new data scheduled for the mobile terminal will be conveyed to the serving BTS 18.

C. The RNC 22 informs the target BTS 20 that a cell change/handover is about to occur, and provides target BTS 20 with the mobile equipment 10 information (e.g., its identity), and begins conveying new data to the target BTS 20 transmission buffer.

D. The serving BTS 18 indicates to the mobile equipment 10 when transmitting the last data packet it received from the RNC 22 that this is the last data packet that the serving BTS 18 will transmit to the mobile terminal 10, thereby triggering the mobile terminal 10 to begin the handover. This last packet is preferably retransmitted until an acknowledgment (ACK) is received from the mobile terminal 10 indicating that the mobile terminal 10 received that last packet from the serving BTS 18.

E. The mobile terminal 10 notifies the target BTS 20 of the change, e.g. with a specific message on HS-DPCCH that the mobile terminal 10 is now ready to receive the HSPDA transmissions from the target BTS 20. The target BTS 20 may, in some embodiments, also notify the RNC 22 of the successful change in response to receiving that notification from the mobile terminal 10. This may be implemented by merely relaying the notification message received from the mobile terminal (termed herein a handover confirmation message), or by setting a bit or series of bits in a packet in a pre-arranged manner.

It is noted that this notification in step D above from the serving BTS 18 to the mobile terminal 10 identifying the last data packet may be either in a physical layer (e.g., through the use of a different H-RNTI for indicating the last packet) or on a MAC layer. Also, a specific end-of-transmission packet or notification may be used after sending the last payload (data) packet. Alternatively, one of the signaling combinations on the HS-SCCH may be used, for example, an indication of one of fifteen codes and particular data rate corresponds to an indication of “last packet”. Further, in this regard during 3GPP discussion for HSDPA development some modulation/code/coding combinations were found to be unusable, even though supported in the HS-SCCH signaling space. Thus, one of these “unusable” combinations could be employed as a last packet indicator to the mobile terminal 10, and if sent on a shared control channel, the next data packet sent on a downlink shared data channel will be understood as the “last data packet” by all of the network nodes and the mobile terminal. Any of the above approaches may be considered as identifying a particular data packet as the last data packet, or a separate series of bits within a packet (preferably within that “last data packet” to minimize how many bits are necessary to identify a packet) or a completely separate packet may be used to identify the last data packet.

It is preferred that the serving BTS 18 notify the RNC 22 if the last packet notification did not go through after a reasonable number of retries so that RNC 22 knows that the cell change may have failed.

It is also preferred that the serving BTS 18 notify the RNC 22 when the last packet notification is acknowledged by the mobile equipment 10 so that the RNC 22 is informed of the success of the cell change operation, and the serving BTS 18 (or the RNC 22) can thereby release those radio resources that were allocated to the mobile terminal 10 prior to the handover. An automatic resource release may also be employed at the serving BTS 18.

If the mobile terminal 10 does not receive a last packet indication, and has reason to believe that the HSDPA connection to the serving BTS 18 has been lost, in one embodiment it may then perform the handover to the target BTS 20 based on certain criteria. The criteria may be, as non-limiting examples, one or more of: serving BTS 18 CPICH quality too low, or too long a time since the last HSDPA transmission from the serving BTS 18 was received.

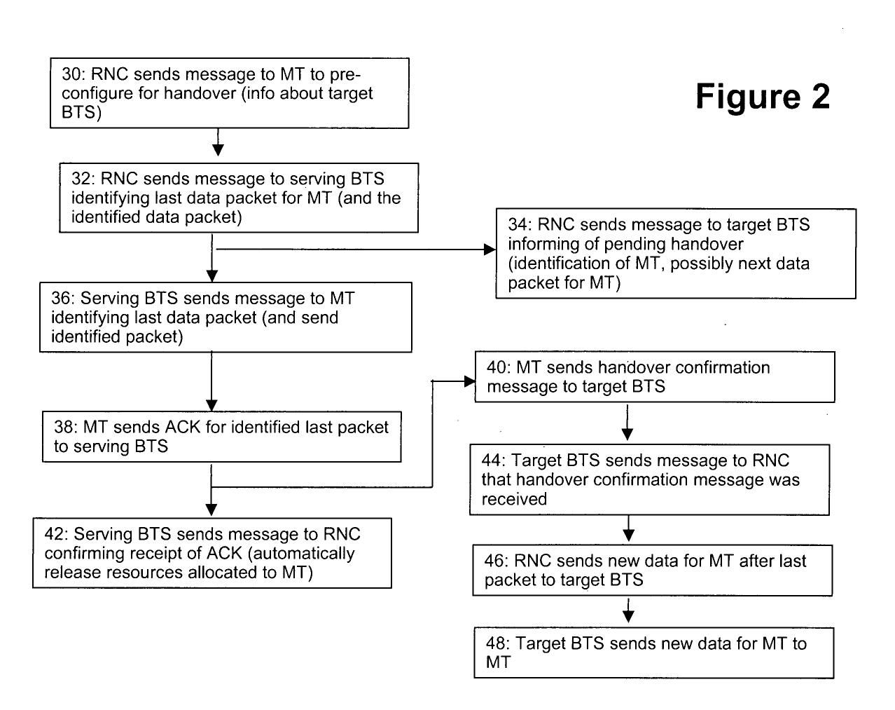

In order to recover from a lost HS-DPCCH notification/handover confirmation that should go from the mobile terminal 10 to the target BTS 20, the mobile terminal 10 may continue sending the notification until the target BTS 20 sends its first data packet to the mobile terminal 10. The target BTS 20 may know to send its data packets to the mobile terminal 10 by receiving from the RNC 22 an indication that handover is completed at the mobile terminal 10, which the RNC 22 knows from the last packet acknowledgement received at the serving BTS 18 and confirmed to the RNC 22. Alternatively, a timer may be used whereby if no HS-DPCCH notification/handover confirmation from the mobile terminal 10 is received at the target BTS 20 before expiration of the timer, the target BTS 20 assumes that the mobile terminal 10 has successfully made the transition to the target BTS 20 and begins scheduling packet transmission to the mobile terminal 10. The timer may operate in parallel with a similar timer in the mobile terminal 10 so that the serving cell is changed regardless of whether the last packet notification from the serving BTS 18 is received at the mobile terminal 10. These options are seen as backup propositions in the event the signaling shown in FIGS. 1 and 2 fail to function properly due to packet error or lost packets/signals.

FIG. 2 is a process flow diagram showing signaling between the various network elements in accordance with one embodiment of the invention. Reference numbers used for the various communications in FIG. 1 are used again for the similarly described communications shown in FIG. 2. It will be appreciated that the various steps need not be executed in the exact order described or illustrated, though the context will show that some steps/messages are necessarily predicate to other steps/messages. At block 30, the RNC 22 sends a message to the mobile terminal to pre-configure for a handover from the serving BTS 18 to the target BTS 20. This message may be routed preferably through the serving BTS 18, or may be communicated to the mobile terminal 10 by any other pathway and on a data or a control channel. This message from the RNC 22 may identify the target BTS 20, may identify a specific channel (e.g., a shared control channel) of the target BTS 20 over which the mobile terminal 10 may expect contact, and the like.

At block 32, the RNC 22 sends a message to the serving BTS 18 identifying a particular data packet as the last data packet that will be sent, prior to the handover, from the serving BTS 18 to the mobile terminal 10. This message may be combined with the message of block 30, and/or the particular (last) data packet may be sent to the serving BTS 18 in a modulation/data rate/spreading code combination (as detailed above) that is predetermined throughout the network and mobile terminal 10 to indicate a “last” packet, and reserved for that purpose. Relatedly, the RNC 22 sends in block 34 a message to the target BTS 20 informing the target BTS 20 of the impending handover. Preferably, this message identifies the mobile terminal 10 and may also be combined with a data packet that is intended to be the first data packet that the target BTS 20 downloads to the mobile terminal 10 once the handover is completed (in the mobile terminal's view, as indicated by block 40).

Upon receiving the indication of “last” data packet from the RNC 22, the serving BTS 18 sends an indication to the mobile terminal identifying a particular data packet as the last data packet. Efficiently, the actual “last” data packet may be sent to the mobile terminal at a particular combination of modulation/data rate/spreading code that indicates “last data packet” that is previously arranged to convey that indication, such as one of the “unusable” combinations noted above. Such a combination should be reserved only for conveying that indication, and be unique as compared to all other combinations of modulation/coding rate/spreading code (or at least two of those parameters).

Upon receipt form the serving BTS 18 of the particular data packet that is identified as the “last” data packet, the mobile terminal 10 then sends an acknowledgement at block 38 to the serving BTS 18, informing it that the “last” data packet has been received. The serving BTS 18 may then automatically release radio resources previously allocated to that mobile terminal 10 as the handover is seen as complete from the serving BTS's perspective, and the serving BTS 18 sends at block 42 a message to the RNC 22 a conformation that the acknowledgement of block 38 has been received from the mobile terminal 10.

Also upon receiving that particular packet that was identified to it as the “last” data packet, the mobile terminal 10 sends at block 40 a handover confirmation message to the target BTS 20. This informs the target BTS 20 that the mobile terminal 10 is now under its control, and that the mobile terminal 10 is configured and ready to receive data packets from the target BTS 20. At this point the target BTS 20 is actually the new serving BTS 20, but this description will use the previously employed terminology to distinguish the BTS's without confusion. Preferably, the handover confirmation message is sent from the mobile terminal 10 to the target BTS 20 over a control channel, that channel for which it pre-configured based on the message of block 30. Upon receiving the handover confirmation message, the target BTS 20 sends at block 44 a confirmation message to the RNC 22 confirming that the handover confirmation message has been received from the mobile terminal 10. The RNC 22 now recognizes that the handover is complete, and sends to the target BTS 20 at block 46 a “first” data packet to be sent on a downlink to the mobile terminal 10, which the target BTS 20 sends to the mobile terminal 10 at block 48.

Note that the RNC 22 need not await receipt from the target BTS 20 of the message described at block 44 before sending the “first” data packet to the target BTS 20. Preferably, this is sent earlier in time so that the target BTS 20 can schedule that “first” data packet as soon as possible once it receives the handover confirmation message (or once a timer runs out in the alternatives detailed above). For example, the RNC 22 may send the “first” data packet to the target BTS 20 at block 34 with the message informing the target BTS 20 of the pending handover, or it may send it separately from sending that block 34 message to the target BTS 20 but prior to the receiving from the target BTS 20 the message of block 44.

By the above manner, the RNC 22 knows exactly which will be the “last” data packet from the serving BTS 18 and which will be the “first” data packet from the target BTS 20, eliminating the RNC 22 having to delay the exact time until handover occurs in order to allow the serving BTS to employ its buffer of packets destined for the mobile terminal. Most particularly by using a unique combination of modulation, rate and spreading code (or at least two of them), the indication of “last” data packet and even possibly “first” data packet as detailed above may be done without additional signaling; such indications would be inherent in the unique combination that would be understood among the various elements 10, 18, 20, 22 as indicative of that status for a particular data packet.

Based on the foregoing description of non-limiting embodiments of this invention it can be appreciated that an aspect of this invention relates to apparatus, methods and a computer program to operate the mobile terminal 10 to perform a handover from a serving cell (BTS 18) to a target cell (BTS 20) by receiving an indication from the serving cell that indicates transmission of a last downlink packet from the serving cell, to acknowledge receipt of the indication and to send an indication to the target cell that it is ready to begin reception of a next DL packet from the target cell.

Based on the foregoing description of non-limiting embodiments of this invention it can be further appreciated that an aspect of this invention relates to apparatus, methods and a computer program to operate a serving BTS 18 to perform a handover of the mobile terminal 10 from that serving BTS 18 to a target BTS 20 by sending, in response to an indication from the RNC 22, a message to the mobile terminal 10 that includes an indication from the serving BTS 18 that indicates transmission of a last downlink packet from the serving BTS 18 is occurring or has occurred, that is responsive to an acknowledgment from the mobile terminal 10 of receipt of the last downlink packet to send a message to the RNC 22 that the serving BTS 18 has successfully handed-over the mobile terminal 10 to the target BTS 20, and when operating as the target BTS 20, to be responsive to a message from the mobile terminal 10 to begin the downlink transmission of a next packet after the last packet sent from the serving BTS 18.

Based on the foregoing description of non-limiting embodiments of this invention it can be further appreciated that an aspect of this invention relates to apparatus, methods and a computer program to operate the RNC 22 to perform a handover of the mobile terminal 10 from a serving cell to a target cell by preconfiguring, in response to a determination to handover the mobile terminal 10, the mobile terminal 10 with knowledge of the target BTS 20, by sending an indication to a serving BTS 18 of a last packet to be sent by the serving BTS 18, and by directing a next packet after the last packet to the target BTS 20 for delivery to the mobile terminal 10.

A number of advantages can be realized by the use of the presently described embodiments of this invention. These advantages include, but need not be limited to, the following: if the handover procedure is successful, no packets are lost; if the handover procedure is successful, the transition is substantially seamless, with no service interruption; and relatively minor changes are required in the implementing specifications and standards, including defining a mechanism (L1 or L2) for the serving BTS 18 to indicate that the last packet was sent, preconfiguration signaling on L3, which is a small change to existing serving cell change signaling, and BTS to RNC signaling for indicating that the presence of the last packet and the related success/failure messaging.

In general, the various embodiments of the mobile terminal 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The mobile terminal 10 also contains a wireless section that includes a digital signal processor (DSP) that may be within the illustrated DP 14 or a separate processor, or equivalent high speed processor or logic, as well as a wireless transceiver 12 that includes a transmitter and a receiver, both of which are coupled to an antenna for communication with the network serving and target nodes. At least one local oscillator, such as a frequency synthesizer, is provided for tuning the transceiver. Data, such as digitized voice and packet data, is transmitted and received through the antenna. The wireless section may be considered to function as a long-range interface (e.g., hundreds or thousands of meters) to the target and serving nodes or base stations which are a part of the network 50. Note that the mobile terminal 10 may also include a local area wireless transceiver, such as one based on Bluetooth™ low power RF or infrared (IR) technology. Such a local area transceiver may be considered as a short range interface (e.g., meters or tens of meters) for coupling to a wireless local area network (WLAN) via a suitable access point, but such a local transceiver is considered incapable of communicating with the UTRAN network 50 due to range and power requirements for the network.

The data processor 14 is coupled to some type of a memory 16, including a non-volatile memory for storing an operating program and other information, as well as a volatile memory for temporarily storing required data, scratchpad memory, received packet data, packet data to be transmitted, and the like. The operating program is assumed, for the purposes of this invention, to enable the DP 14 to execute the software routines, layers and protocols required to implement the methods and functions in accordance with the exemplary embodiments of this invention. Although not shown, a microphone and speaker are typically provided for enabling the user to conduct voice calls in a conventional manner.

The exemplary embodiments of this invention may be implemented by computer software executable by the data processor 14 of the mobile terminal 10 or by a data processor within the network nodes 18, 20. Execution may be by a combination of software and hardware.

The memory 16 may be of any type suitable to the local technical environment and may be implemented using any suitable data storage technology, such as semiconductor-based memory devices, magnetic memory devices and systems, optical memory devices and systems, fixed memory and removable memory. The data processor(s) 14 may be of any type suitable to the local technical environment, and may include one or more of general purpose computers, special purpose computers, microprocessors, digital signal processors (DSPs) and processors based on a multi-core processor architecture, as non-limiting examples.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. As but some examples, the use of other similar or equivalent messages and/or signaling techniques may be attempted by those skilled in the art. However, all such and similar modifications of the teachings of this invention will still fall within the scope of this invention.

Furthermore, some of the features of the examples of this invention may be used to advantage without the corresponding use of other features. As such, the foregoing description should be considered as merely illustrative of the principles, teachings, examples and embodiments of this invention, and not in limitation thereof.

What is claimed is:

1. A system for handing over a mobile terminal from a serving base transceiver station BTS to a target BTS, comprising:
a radio network controller RNC comprising RNC means for communicating with a serving BTS and a target BTS, an RNC processor coupled to an RNC memory for executing a first set of instructions stored on the RNC memory, for sending a first message to one of the serving and target BTSs directed to the mobile terminal to preconfigure for a handover to the target BTS, for sending a second message to the serving BTS comprising a particular data packet directed to the mobile terminal and an indication that the particular data packet is a last data packet, and for sending a third message to the target BTS informing of a pending handover of the mobile terminal to the target BTS;
wherein the serving BTS comprises serving means for communicating with the RNC, a serving antenna coupled to a serving transceiver for communicating with the mobile terminal, a serving processor coupled to a serving memory for executing a second set of instructions stored on the serving memory for sending, responsive to receiving the first message, a fourth message to the mobile terminal identifying the particular data packet as the last data packet, and for sending, responsive to receiving at the serving antenna an acknowledgement of receipt by the mobile terminal of the particular data packet, a fifth message to the RNC informing of receipt by the serving BTS of the acknowledgement; and
wherein the target BTS comprises target means for communicating with the RNC, a target antenna coupled to a target transceiver for communicating with the mobile terminal, a target processor coupled to a target memory for executing a third set of instructions stored on the target memory for receiving the third message, and responsive to receiving a handover confirmation message from the mobile terminal, for sending a sixth message to the RNC informing of receipt by the target BTS of the handover confirmation message, and for thereafter scheduling data packets for transmission to the mobile terminal via the target antenna.

2. A method for operating a mobile terminal, comprising:
receiving from a serving base transceiver station BTS a data packet and an indication that the said data packet is a last data packet to be sent from the serving BTS; and
recognizing the indication as a handover of the mobile terminal from the serving BTS to a target BTS.

3. The method of claim 2, further comprising:
responsive to receiving both the data packet and the indication, sending a handover confirmation message to a target BTS informing that the mobile terminal is handed over to the target BTS.

4. The method of claim 2 further comprising, prior to receiving the indication:
receiving from a network that comprises the serving BTS and the target BTS a message bearing information about the target BTS; and
after receiving both the data packet and the indication, initiating communication with the target BTS using the information.

5. The method of claim 2 further comprising:
responsive to receiving both the data packet and the indication, sending an acknowledgement to the serving BTS that the said data packet has been received; and
following sending the acknowledgement, automatically discontinuing monitoring a channel over which the said data packet was received.

6. A mobile terminal comprising:
an antenna;
a transceiver coupled to the antenna for receiving from a serving base transceiver station BTS a downlink data packet and an indication that the downlink data packet is a last data packet to be sent from the serving BTS;
a processor coupled to the transceiver; and
a memory coupled to the processor for storing a set of instructions, executable by the processor, for sending an uplink data packet to a target BTS separate from the serving BTS, after receiving the indication.

7. The mobile terminal of claim 6, wherein the set of instructions, executed by the processor, are further for compiling a handover confirmation message directed to the target BTS informing that the mobile terminal is handed over to the target BTS and for sending the handover confirmation message to the target BTS, wherein compiling and sending are automatically responsive to receiving the indication.

8. The mobile terminal of claim 7, further wherein the set of instructions are for, automatically responsive to receiving the indication:
compiling and sending an acknowledgement to the serving BTS that the said indication has been received; and
following sending the acknowledgement, automatically discontinuing monitoring a channel over which the downlink data packet was received.

9. A program of machine-readable instructions, tangibly embodied on an information bearing medium and executable by a digital data processor, to perform actions directed toward handing over a mobile terminal between network elements, the actions comprising:
determining from a message received from a serving base transceiver station BTS that a downlink data packet from the serving BTS is a last data packet to be received from the serving BTS; and
following determining, sending an uplink data packet to a target BTS.

10. The program of claim 9, wherein the actions further comprise, responsive to receiving the message, compiling and sending from the transceiver a handover confirmation message to the target BTS informing that a mobile terminal in which the program is resident is handed over to the target BTS.

11. The program of claim 9 wherein the actions further comprise, prior to receiving the indication:
receiving from a network that comprises the serving BTS and the target BTS a message bearing information about the target BTS; and
after receiving the message and prior to sending the uplink data packet, initiating communication with the target BTS using the information.

12. The program of claim 9, wherein the actions further comprise:
responsive to receiving the message, compiling and sending an acknowledgement to the serving BTS that the said message has been received; and
following sending the acknowledgement, automatically discontinuing monitoring a channel over which the said data packet was received.

13. A method for operating a serving base transceiver station BTS, comprising:
receiving from a radio network controller RNC a first indication that a handover of a mobile terminal from the serving BTS is about to occur;
following receiving the first indication, sending a message to the mobile terminal that indicates that a particular data packet is a last data packet.

14. The method of claim 13, further comprising:
following sending the message and the particular data packet to the mobile terminal, receiving from the mobile terminal an acknowledgement of receipt of the particular data packet; and
automatically responsive to receiving the acknowledgement, releasing radio resources allocated to the mobile terminal.

15. The method of claim 14, further comprising:
following receiving the acknowledgement, sending a message to the RNC informing that the acknowledgement has been received.

16. The method of claim 13, wherein sending the message comprises sending the particular data packet with a combination of at least two parameters selected from the set modulation, data rate and spreading code; said combination predetermined to indicate that any data packet sent with said combination is a last data packet prior to handover.

17. A serving network element comprising:
an antenna;
a transceiver coupled to the antenna for receiving from a radio network controller RNC an indication that a handover of a mobile terminal from a serving network element is about to occur;
a processor coupled to the transceiver; and
a memory coupled to the processor for storing a set of instructions, executable by the processor, for compiling, following receipt of the indication, a message to the mobile terminal that identifies a particular data packet as a last data packet and for sending the message to the mobile terminal.

18. The serving network element of claim 17, further wherein:
the transceiver is further for receiving from the mobile terminal an acknowledgement of receipt of the last data packet;
and further wherein the set of instructions is for releasing radio resources allocated to the mobile terminal, automatically in response to receiving the acknowledgement.

19. The serving network element of claim 18, further wherein the set of instructions is for:
following receipt of the acknowledgement, compiling and sending a message to the RNC informing that the acknowledgement has been received.

20. The serving network element of claim 17, wherein compiling and sending the message that identifies the particular data packet comprises sending the particular data packet with a combination of at least two parameters selected from the set modulation, data rate and spreading code; said combination predetermined to indicate that any data packet sent with said combination is a last data packet prior to handover.

21. A program of machine-readable instructions, tangibly embodied on an information bearing medium and executable by a digital data processor, to perform actions directed toward handing over a mobile terminal between network elements, the actions comprising:
determining from a first message received from a radio network controller RNC that a handover of a mobile terminal from a serving BTS in which the program is resident is about to occur;
following receiving the first message, compiling and sending a second message to the mobile terminal that identifies a particular data packet as a last data packet.

22. The program of claim 21, further comprising:
following sending the second message and the particular data packet to the mobile terminal, determining that the particular data packet has been received at the mobile terminal; and
automatically responsive to determining that the particular data packet has been received at the mobile terminal, releasing radio resources of the serving BTS allocated to the mobile terminal.

23. The program of claim 22, further comprising:
following determining that the particular data packet has been received at the mobile terminal, compiling and sending a message to the RNC informing that the mobile terminal has received the particular data packet.

24. The program of claim 21, wherein compiling and sending a second message to the mobile terminal that identifies the particular data packet comprises sending the particular data packet with a combination of at least two parameters selected from the set modulation, data rate and spreading code; said combination of at least two parameters predetermined to indicate that any data packet sent with said combination is a last data packet prior to handover.

25. A method for operating a target network element comprising:
receiving from a radio network controller RNC a message that a handover of a mobile terminal is about to occur and a first data packet for the mobile terminal;
receiving from the mobile terminal a handover confirmation message;
responsive to receiving the message that a handover is about to occur, allocating a radio resource of a target network element executing the method to the mobile terminal;
responsive to receiving a handover confirmation message, sending the first data packet to the mobile terminal over the allocated radio resource.

26. The method of claim 25, further comprising:
responsive to receiving the handover confirmation message, sending a message to the RNC that the handover confirmation message was received at the target network element.

27. A target network element comprising:
an antenna;
a transceiver coupled to the antenna for receiving from a radio network controller RNC a message that a handover of a mobile terminal to the target network element is about to occur and a first data packet for the mobile terminal, and for subsequently receiving from the mobile terminal a handover confirmation message;
a processor coupled to the transceiver; and
a memory coupled to the processor for storing a set of instructions, executable by the processor, for allocating a radio resource of the target network element to the mobile terminal in response to receiving the message that a handover is about to occur, and for automatically sending the first data packet to the mobile terminal over the allocated radio resource in response to receiving the handover confirmation message.

28. The target network element of claim 27, further wherein the set of instructions is for:
automatically in response to receiving the handover confirmation message, compiling and sending a message to the RNC that the handover confirmation message was received at the target network element.

29. A program of machine-readable instructions, tangibly embodied on an information bearing medium and executable by a digital data processor, to perform actions directed toward handing over a mobile terminal between network elements, the actions comprising:
responsive to receiving from a radio network controller RNC a message that a handover of a mobile terminal is about to occur and a first data packet for the mobile terminal, allocating to the mobile terminal a radio resource of a target network element in which the program is resident;
responsive to receiving a handover confirmation message from the mobile terminal, sending the first data packet to the mobile terminal over the allocated radio resource.

30. The program of claim 29, wherein the instructions further comprise:
responsive to receiving the handover confirmation message, sending a message to the RNC that the handover confirmation message was received at the target network element.

31. A method for operating a radio network controller, comprising:
sending a first message directed toward a mobile terminal informing the mobile terminal to configure for a pending handover to a target network element;
sending a second message to a serving network element currently serving the mobile terminal that identifies a particular data packet directed toward the mobile terminal as a last data packet to be sent prior to the pending handover;
sending a third message to the target network element informing of the pending handover and identifying the mobile terminal.

32. The method of claim 31, wherein the second message comprises the particular data packet.
